(19) United States
(12) Patent Application Publication
(10) Pub. No.: US 2026/0214369 A1
(43) Pub. Date: Jul. 23, 2026

(54) AIRCRAFT AUDIO PANEL INCLUDING USB TYPE-C ANALOG AUDIO INTERFACE

(71) Applicant: Textron Aviation Inc., Wichita, KS (US)

(72) Inventor: Adam Ryan PAYTON, Wichita, KS (US)

(21) Appl. No.: 19/035,208

(22) Filed: Jan. 23, 2025

(51) Int. Cl. H04R 1/10; H04R 3/12

(52) U.S. Cl. CPC H04R 1/1041; H04R 1/1025; H04R 3/12; H04R 2420/03; H04R 2420/09; H04R 2430/00

(57) ABSTRACT

Certain example embodiments described herein relate to aircraft audio panels that incorporate USB Type-C digital to analog audio interfaces that enable personal electronic devices to deliver audio while also being charged. An audio panel includes a charging module; audio conversion circuitry including multiple digital-to-analog converters (DACs) and a logic circuit; an analog audio output port; and a USB Type-C connector coupled to the charging module and the audio conversion circuitry. The logic circuit is configured to activate one of the DACs in dependence on a data signal received from an electronic device connected to the USB Type-C connector over one of a plurality of differential pin pairs of the USB Type-C connector to provide an analog audio signal to the analog audio output port. The personal electronic devices may be smartphones, tablets, or the like.

### TECHNICAL FIELD

Certain example embodiments described herein relate to audio interfaces for aircraft. More particularly, certain example embodiments described herein relate to aircraft audio panels that incorporate USB Type-C (also sometimes called USB-C) digital to analog interfaces that enable personal electronic devices to deliver audio while also being charged.

### BACKGROUND AND SUMMARY

Aircraft cockpits incorporate increasingly complex and interesting pieces of technology. For example, modern aircraft cockpits include avionics suites that, among other things, allow for communication among people in the cockpit (e.g., a pilot and copilot), between people in the cockpit and people in other aircraft, and between people in the cockpit and the ground. An audio panel in a cockpit connected to the avionics suite typically will receive connectors from a headset to facilitate such communications.

Avionics suites also allow for communication between the cockpit and the cabin. In this regard, a pilot or copilot might, for example, make an announcement to passengers in the aircraft cabin using a headset connected to the audio panel. But in some instances, avionics suites also allow other sources of sound to be provided into a cabin from a cockpit. For instance, a pilot or copilot might connect a personal electronic device (such as a smartphone, tablet, or the like) to an audio panel. In this way, music or other audio stored to, or otherwise accessible by, the personal electronic device can be played locally on the device but “piped into” the cabin, e.g., for passenger enjoyment. Such audio might also be provided to headsets connected to the audio interface, and the avionics suite may manually or automatically prioritize the audio output to the headset.

FIG. 1 is a view of an audio panel provided in some current Cessna Citation XLS cockpits. As will be appreciated from the FIG. 1 view, the audio panel is connected to an avionics suite, and a headset can be connected to the avionics suite via the audio panel using the analog inputs at the left. A 3.5 mm analog input (also sometimes called an auxiliary jack) is provided at the left of the audio panel. This 3.5 mm analog input can be used to provide optional audio entertainment from a personal electronic device (PED). The audio panel receives data from the analog input and conveys it to the avionics suite, which distributes it through the aircraft as appropriate.

FIG. 2 is a view of an audio interface provided in some current Cessna Citation CJ3 cockpits. As with FIG. 1, the FIG. 2 audio panel is connected to an avionics suite, and a 3.5 mm analog input at the top of the audio panel allows optional audio entertainment to be provided to the aircraft as appropriate. A USB port (typically a USB Type A port) at the bottom of the FIG. 2 audio panel enables a PED to be charged. A headset may be connected to the avionics suite via inputs provided elsewhere in the cockpit. It will be appreciated that different companies may supply the aircraft, avionics suite, audio panels, headsets, and/or other components, etc., in different instances.

The FIG. 2 audio panel has been well received in that it has allowed flight crews to provide audio entertainment (e.g., it has allowed flight crews to play music) from PEDs via the 3.5 mm auxiliary jack while also charging their PEDs through the USB port. Unfortunately, however, this setup is a bit outdated in terms of current PED connection options. That is, many or even most modern PED models no longer have auxiliary audio out jacks that would allow a connection to the 3.5 mm audio ports in FIG. 2 example audio panels. The same also is true for FIG. 1 example audio panels that also include 3.5 mm audio ports. Many or perhaps most modern PED models instead have single USB Type-C (USB-C) or Apple Lighting type outputs.

As a result, flight crews have had to bring adapters and/or multiple cables to connect their devices to current audio panels. These adapters and/or cables, in general, help connect more modern USB-C or Lighting type outputs provided to PEDs to 3.5 mm auxiliary jacks in the audio panels to provide audio. Some more expensive adapters may help provide power to the PED, but they generally have needed two separate connections to an aircraft to work, namely, one cable for audio and one cable for charging. Regardless, these setups can be unwieldy and difficult to manage.

Certain example embodiments help address the above-described and/or other concerns. For example, certain example embodiments relate to aircraft audio panels that incorporate USB Type-C digital to analog audio interfaces that enable personal electronic devices to deliver audio while also being charged.

One aspect of certain example embodiments relates to the ability to eliminate the need for flight crews to use complicated adapters and/or cables to provide audio input to aircraft from personal electronic devices while also charging those personal electronic devices.

Another aspect of certain example embodiments relates to an aircraft audio panel that enables personal electronic device charging and audio input to occur through a common (i.e., the same) port and, for example, a single USB-C cable.

In certain example embodiments, an audio panel is provided. The audio panel includes a charging module; audio conversion circuitry comprising a plurality of digital-to-analog converters (DACs) and a logic circuit; an analog audio output port; and a USB Type-C connector coupled to the charging module and the audio conversion circuitry. The logic circuit is configured to selectively activate one of the plurality of DACs in dependence on a data signal received from an electronic device connected to the USB Type-C connector over one of a plurality of differential pin pairs of the USB Type-C connector (e.g., the A6/A7 differential pin pair or the B6/B7 differential pin pair), e.g., to provide an analog audio signal to the analog audio output port, with the electronic device being chargeable by the charging module while the analog audio signal is being provided to the analog audio output port.

In certain example embodiments, the audio conversion circuitry may further comprise a stepdown circuit.

In certain example embodiments, the DACs may be activatable in response to receiving power from the charging module via the stepdown circuit.

In certain example embodiments, a single printed circuit board may support the stepdown circuit, the logic circuit, and/or the plurality of DACs. In some instances, the printed circuit board may further support the analog audio output port.

In certain example embodiments, the plurality of DACs may include a first DAC and a second DAC, e.g., with the first DAC being activatable responsive to the data signal having a first format and with the second DAC being activatable responsive to the data signal having a second format different from the first format.

In certain example embodiments, a configuration signal received over a configuration channel of the USB Type-C connector may indicate which pins in the USB Type-C connector are to be used for the data signal and which pins in the USB Type-C connector are to be used for charging of the electronic device.

In certain example embodiments, the plurality of DACs may include a first DAC and a second DAC, e.g., the first DAC being configured to process digital audio data received from a first device type, and with the second DAC being configured to process digital audio data received from second device type different from the first device type. For instance, the first device type may be a portable electronic device running Android operating system and the second device type may be a portable electronic device running iOS.

In certain example embodiments, the charging module may be configured to share charging-related data with the electronic device via the USB Type-C connector.

In certain example embodiments, the logic circuit may be implemented as an OR gate.

Certain example embodiments relate to an aircraft comprising the audio panel described herein. The audio panel may, for example, be provided in a cockpit of the aircraft. In certain example embodiments, the charging module may be configured to receive power from the aircraft.

In certain example embodiments, an audio control system, to which the analog audio output port is connected, may be provided.

In certain example embodiments, the audio control system may be configured to provide audio from the electronic device to one or more headsets connected to the audio control system while the electronic device is charging via the USB Type-C connector of the audio panel.

In certain example embodiments, the audio control system may be configured to provide audio from the electronic device to speakers in a cabin of the aircraft while the electronic device is charging via the USB Type-C connector of the audio panel.

In certain example embodiments, a method of providing analog audio to an audio system from a source electronic device connected to a USB Type-C port while also charging the source electronic device over the same USB Type-C port may be provided. The USB Type-C port comprises a plurality of pairs of differential pins. The method comprises: receiving a data signal from one of the pairs of differential pins in the USB Type-C port; providing the data signal to one of a plurality of different digital-to-analog converters (DACs) based on the data signal; providing the analog audio to the audio system from the one of the plurality of different digital-to-analog converters (DACs) to which the data signal was provided; determining that the source electronic device should be charged while the analog audio is being provided to the audio system based on a charging signal received via the USB Type-C port; and charging the source electronic device based on the determination.

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a view of an audio panel provided in some current Cessna Citation XLS cockpits;

FIG. 2 is a view of an audio interface provided in some current Cessna Citation CJ3 cockpits;

FIG. 3 is a view of a visible portion of an audio panel in accordance with certain example embodiments;

FIG. 4 is a block diagram showing components that may be used in connection with certain example embodiments; and

FIG. 5 is a block diagram showing a more detailed view of electronics that may be used to implement the approach of certain example embodiments.

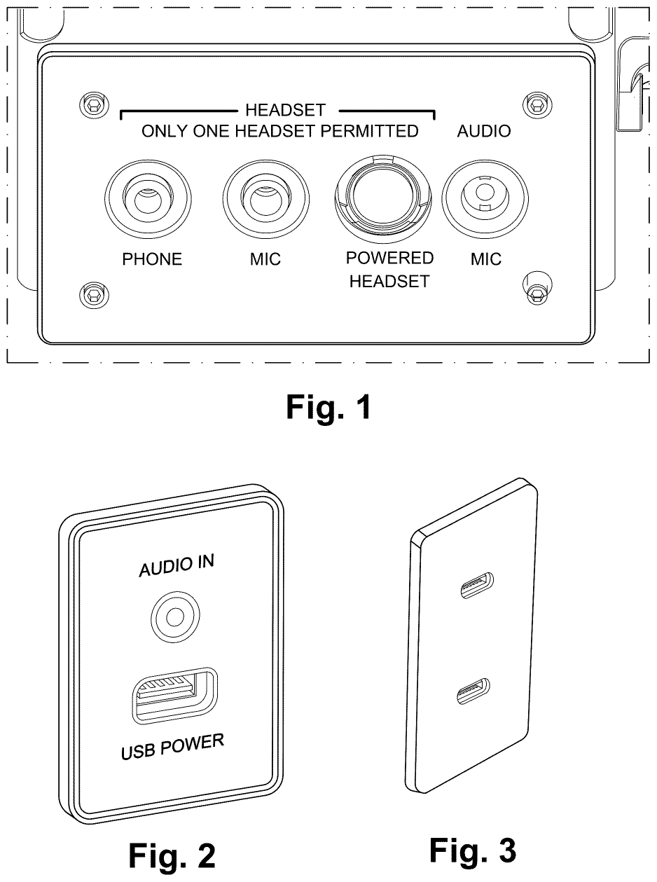

### DETAILED DESCRIPTION

Certain example embodiments described herein relate to aircraft audio panels that incorporate USB Type-C digital to analog audio interfaces that enable personal electronic devices to deliver audio while also being charged. The aircraft audio panels of certain example embodiments advantageously enable personal electronic device charging and audio input to occur through a common port and a single cable (i.e., the same port and e.g., a single USB-C to USB-C cable, a single Apple Lightning to single USB-C cable, etc.). As will be appreciated from the description below, the audio panels of certain example embodiments incorporate a circuit that can convert between digital data used in modern PEDs and analog data expected by some current avionics suites (such as, for example, current the Garmin Avionics Suite), e.g., to allow audio entertainment to be provided in crew headsets and/or throughout the aircraft. Doing so can eliminate the need for complicated adapters and/or wires, while also providing an audio signal in a format expected by current avionics suites. With regard to the latter, current avionics suites in aircraft typically expect analog audio signals, which are not currently passed through typical USB-C ports. Certain example embodiments provide audio panels with one or more (e.g., two) USB-C ports and connected circuitry that separate out and convert an audio signal being passed from a source PED through the USB-C port to analog and feed it to the aircraft systems, while also allowing the source PED to be charged.

FIG. 3 is a view of a visible portion of an audio panel in accordance with certain example embodiments. The FIG. 3 view is human accessible, e.g., visible from the cockpit, and includes two USB-C connectors in a stacked configuration. It will be appreciated that different example embodiments may include more or fewer USB-C connectors in the same or different configuration (e.g., in a stacked, side-by-side, matrix, or other configuration). In some instances, one port may be provided for charging and audio conversion and another other port may be provided for charging only. In some instances, one port may be provided for handling a first audio protocol and charging while another port may be provided for handling a second audio protocol and charging. In this case, for example, one port may be provided for handling an Apple audio protocol and thus may be used to enable charging and audio delivery from such devices while the other port allows for charging only; likewise, one port may be provided for handling an Android audio protocol and thus may be used to enable charging and audio delivery from such devices while the other port allows for charging only. It will be appreciated that this more dedicated configuration may obviate the need for a signal identification (ID) chip (or logic circuit/logic chip, e.g., as described in greater detail below) in some cases because there would only be one corresponding digital-to-analog converter (DAC) for each port. It also will be appreciated that other connectors may be provided in other example embodiments, e.g., to provide for legacy integration and/or other services. For instance, 3.5 mm jacks, quarter-inch plugs, powered headphone plugs, and/or the like may be provided in different example embodiments.

Hidden behind the panel are a host of electronics components including, for example, logic circuits/logic chips, resistors, capacitors, and DACs. Using this circuitry, certain example embodiments are able to convert a digital signal from a source PED or other electronic device attached to a USB-C port and allow for analog data transmission to the aircraft (e.g., to an avionics suite in the aircraft) while still allowing the USB-C port to charge the device.

In certain example embodiments, digital data is sent from the PED over a differential pair located at either pins A6 and A7 or B6 and B7 in the USB Type-C connector, depending on the orientation of the controller. That is, as is known, a USB-C connector is a 24-pin connector that can carry audio, video, and/or other data. The pinout configuration of a USB-C connector attempts to be reversible; that is, a USB-C connector has a symmetrical design, allowing for reversible connections. In a USB-C connector, pins A5 and B5 are channel configuration pins CC1 and CC2, which work based on the orientation of the cable and advise which pins should be used for charging and which pins should be used for data. Pins A6 and A7, or B6 and B7, work together as D+ and D− data lines that support high-speed data transfer in a variety of different USB standards. The A6/A7 or B6/B7 pins are used for transmitting audio data in certain example embodiments because they are capable of transmitting analog data. Apple Lightning connectors have different layouts compared to USB-C connectors. Pins 4 and 8 of Apple Lightning connectors provide identification/control signals and can be connected to the channel configuration pins CC1 and CC2, e.g., to convert between Apple Lightning connectors and USB connectors.

The data from the PED is passed to a logic circuit/logic chip such as, for example, an OR gate, XOR gate, or other configuration, to differentiate between different types of devices that might be plugged in. For example, Apple devices (including devices running Apple iOS, such as Apple iPhones, etc.) have in the past made use of Apple Lightning connections, whereas other devices (such as Android-based smartphones/devices running Android operating system) have used standard USB-C connections. The devices also may output digital data in different formats. The logic circuit/logic chip can differentiate between at least these two device types and/or formats, and the data can be passed either through a series of resistors to activate the Apple Lightning port for audio output, or it can be sent to a DAC chip for conversion to analog data readable by the avionics suite (e.g., the Garmin Avionics Suite found in many aircraft). It will be appreciated that the series of resistors may be found on the DAC chip and need not be a separate set of components of certain example embodiments. The appropriate resistance would be established by the activated DAC chip in certain example embodiments. This audio transmission works on a different path compared to the path used for passing charging information data and therefore allows the USB-C port to charge the device simultaneously while using a single point of connection (one cable) to the aircraft. In certain example embodiments, data is sent through the CC1 or CC2 pin to go to logic circuit/logic chip to activate the proper DAC. Audio from pins A6/A7 or B6/B7.

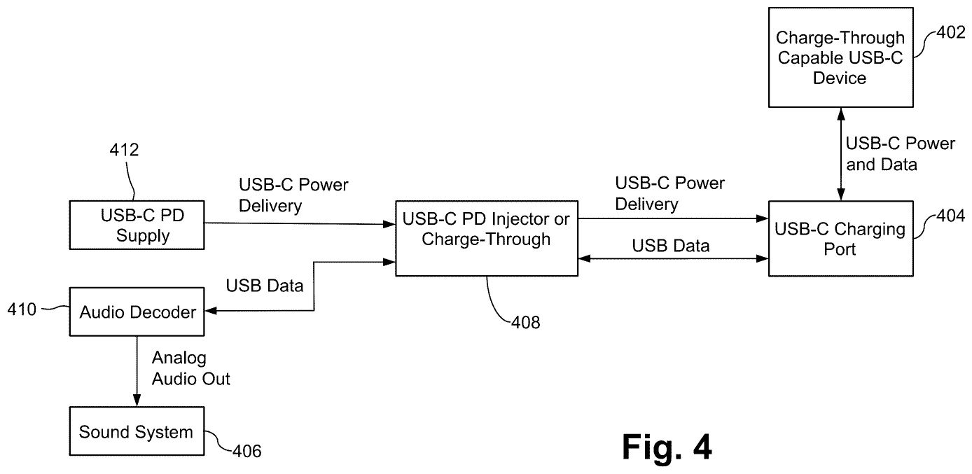

FIG. 4 is a block diagram showing components that may be used in connection with certain example embodiments. FIG. 4 shows a charge-through capable USB-C device 402, which may be a PED such as a smartphone, tablet, or other electronic device. USB-C power and data are passed along a wired connection to a USB-C charging port 404 in the audio panel of certain example embodiments. Two separate paths are provided out of the USB-C charging port 404, namely, a USB data path to the sound system 406 and a USB-C power delivery path. Both of these paths run through a USB-C power delivery (PD) injector or charge-through device 408. The USB-C power delivery PD injector or charge-through device 408 routes the USB data to audio decoding circuitry 410, which ultimately provides analog audio output to the sound system 406 (with the avionics suite potentially being an intermediary component in certain example embodiments). A PD injector, for example, allows communication between the charging port and the device regulating the current of the charger to provide optimum charging without damaging the battery life on the device. A “charge through device,” for example, may be implemented as a “dumb” USB-C port allowing a constant, non-variable amperage charge to flow to the device. The USB data may be shared over any suitable USB hardware interface such as, USB 2.0, USB 3.0, and/or the like. The connection between the USB-C power delivery PD injector or charge-through device 408 provides power to the audio decoding circuitry 410, and the audio decoding circuitry 410 in essence is what “tells” the device 402 it is connected to the sound system 406 (via the port 404). That is, the audio sound system 406 sends a signal to audio decoding circuitry 410, which flows through the PD injector or charge-through device 408 to tell the device 402 there is audio requested and, thus, data is transmitted in both directions. A USB-C PD supply 412 provides power and enables the charge-through capable USB-C device 402 to be charged. Charging-related data also may be shared over the USB data connection between the USB-C charging port 404 and the USB-C power delivery PD injector or charge-through device 408, e.g., to help ensure that the charge-through capable USB-C device 402 is (or is not) receiving an appropriate charge.

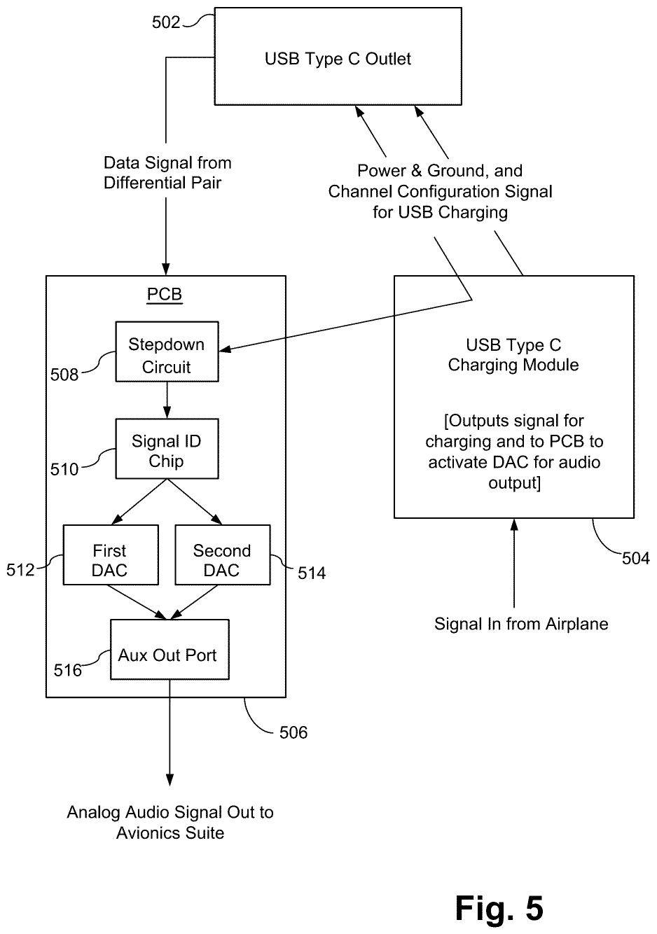

FIG. 5 is a block diagram showing a more detailed view of electronics that may be used to implement the approach of certain example embodiments. The USB Type-C outlet 502 is available to users, as it is exposed through the audio interface panel (e.g., via one or both ports shown in the FIG. 3 example configuration). Concealed behind the audio interface panel in certain example embodiments are a USB Type-C charging module 504 and a printed circuit board (PCB) 506. The USB Type-C outlet 502 may be a part 106453-X USB outlet in certain example embodiments, and the USB Type-C charging module 504 may be a part 106440-1 charging module in certain example embodiments. A power signal in from the airplane (e.g., a 28V signal) is provided to the USB Type-C charging module 504 to provide power to the circuitry shown in FIG. 5, as well as to the PED or other electronic device connected to the USB Type-C Outlet 502. In this regard, the USB Type-C charging module 504 provides power and a ground connection for the USB Type-C outlet 502.

At the USB Type-C Charging module 504, a channel configuration signal is received from the PED or other device connected to the USB Type-C Outlet 502. This helps to communicate charging-related data, e.g., as described above. The USB Type-C Charging module 504 also outputs a signal to the PCB 506 to the stepdown circuit 508, e.g., also as described above. This signal ultimately helps activate the proper DAC for audio output.

The PCB 506 receives a data signal from a differential pair of pins, for example, the differential pair at pins A6 and A7, or B6 and B7, depending on the orientation of the USB connection cable. Moreover, as will be appreciated from the above, the PCB 506 houses a stepdown circuit 508. The stepdown circuit 508 in certain example embodiments converts a 5V signal from the USB Type-C Charging Module 504 (which is expected by the USB Type-C Outlet 502) to a lower voltage signal (e.g., a 3.3V signal). The output from the stepdown circuit 508 activates the signal ID chip 510 (logic circuit/logic chip), which also receives the data signal from the activated differential pair. The signal ID chip 510 in essence decides what type of device is connected to the USB Type-C Outlet 502 and activates the appropriate DAC. The FIG. 5 example embodiment includes a first DAC 512 and a second DAC 514 (although different example embodiments may include more or fewer DACs). If there are only two DACs (e.g., as in the FIG. 5 example embodiment), the signal ID chip 510 may be implemented as a single OR gate or the like. However, it will be appreciated that other circuits may be used in this scenario or more complicated scenarios (e.g., where there are more than two DACs).

In certain example embodiments, the first DAC 512 may be for Android or other standard USB implemented connections, whereas the second DAC 514 may be for Apple Lightning connections. In this regard, the signal ID chip 510 may, for example, OR the data signal received from the device connected to the USB Type-C Outlet 502 and determine whether to route the signal to the first DAC 512 or the second DAC 514 based on the device type connected to the USB Type-C Outlet 502. The output from the activated DAC is provided to the auxiliary out port 516, which provides an analog signal to the avionics suite of the aircraft, as expected.

In many instances, the techniques disclosed herein advantageously can be implemented with simple changes to an audio panel. That is, in certain use cases, the avionics suite, headset connections, and other internal wiring need not be changed to provide a system capable of delivering audio data and powering the device hosting the audio data. In this regard, the techniques disclosed herein advantageously can be implemented by providing a simple faceplate with ports provided on a first, human-accessible side, and a PCB or other structure carrying circuitry provided on a second side opposite to the first side.

It will be appreciated that although the term avionics suite is used, the disclosed technology has applicability beyond avionics (and indeed beyond Garmin products). In general, the technology disclosed herein can be used with other audio or other communication-related control systems. In this regard, although certain example embodiments are described as involving audio panels provided in a cockpit, it will be appreciated that the audio panels may be provided in other locations in an airplane in different example implementations. For instance, panels may be provided at the rear of a plane, in a galley section, near a passenger seat, and/or elsewhere. Moreover, it will be appreciated that similar suites are provided outside of the context of aviation and that other vehicle types (such as ships, buses, etc.) may also expect an analog input and may have similar audio panel limitations. The technology disclosed herein may be useful in these and/or other contexts as well. Indeed, the technology disclosed herein may be useful other industries, vehicles, and/or contexts where audio data is to be passed from a PED to an onboard control system for passenger and/or crew entertainment or other purposes and where, for example, there is a desire to deliver that audio data and simultaneously charge the PED.

It is noted that not all cables marked as being USB-C compliant truly are USB-C compliant. Certain pins may be missing, data speed requirements may not be met, etc. The techniques of certain example embodiments are advantageous in that they typically can be used with many of these non-compliant connector cables, which may be used to connect a PED to the audio panel. That is, such cables are still likely to have at least one set of differential pins and at least one channel configuration pin. As a result, the techniques disclosed herein may still be used for delivering audio while also charging a device, because this minimal set of pins is still likely to be present.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An audio panel, comprising:
a charging module;
audio conversion circuitry comprising a plurality of digital-to-analog converters (DACs) and a logic circuit;
an analog audio output port; and
a USB Type-C connector coupled to the charging module and the audio conversion circuitry;
wherein the logic circuit is configured to selectively activate one of the plurality of DACs in dependence on a data signal received from an electronic device connected to the USB Type-C connector over one of a plurality of differential pin pairs of the USB Type-C connector to provide an analog audio signal to the analog audio output port, the electronic device being chargeable by the charging module while the analog audio signal is being provided to the analog audio output port.

2. The audio panel of claim 1, wherein the audio conversion circuitry further comprises a stepdown circuit.

3. The audio panel of claim 2, wherein the DACs are activatable in response to receiving power from the charging module via the stepdown circuit.

4. The audio panel of claim 2, wherein a single printed circuit board supports the stepdown circuit, the logic circuit, and the plurality of DACs.

5. The audio panel of claim 4, wherein the printed circuit board further supports the analog audio output port.

6. The audio panel of claim 1, wherein the plurality of DACs include a first DAC and a second DAC, the first DAC being activatable responsive to the data signal having a first format, the second DAC being activatable responsive to the data signal having a second format different from the first format, and wherein a configuration signal received over a configuration channel of the USB Type-C connector indicates which pins in the USB Type-C connector are to be used for the data signal and which pins in the USB Type-C connector are to be used for charging of the electronic device.

7. The audio panel of claim 1, wherein the plurality of DACs include a first DAC and a second DAC, the first DAC being configured to process digital audio data received from a first device type, the second DAC being configured to process digital audio data received from second device type different from the first device type.

8. The audio panel of claim 7, wherein the first device type is a portable electronic device running Android operating system and the second device type is a portable electronic device running iOS.

9. The audio panel of claim 1, wherein the charging module is configured to share charging-related data with the electronic device via the USB Type-C connector.

10. The audio panel of claim 1, wherein the logic circuit is implemented as an OR gate.

11. An aircraft comprising the audio panel of claim 1.

12. The aircraft of claim 11, wherein the audio panel is provided in a cockpit of the aircraft.

13. The aircraft of claim 11, wherein the charging module is configured to receive power from the aircraft.

14. The aircraft of claim 11, further comprising an audio control system to which the analog audio output port is connected.

15. The aircraft of claim 14, wherein the audio control system is configured to provide audio from the electronic device to one or more headsets connected to the audio control system while the electronic device is charging via the USB Type-C connector of the audio panel.

16. The aircraft of claim 14, wherein the audio control system is configured to provide audio from the electronic device to speakers in a cabin of the aircraft while the electronic device is charging via the USB Type-C connector of the audio panel.

17. A method of providing analog audio to an audio system from a source electronic device connected to a USB Type-C port while also charging the source electronic device over the same USB Type-C port, the USB Type-C port comprising a plurality of pairs of differential pins, the method comprising:
receiving a data signal from one of the pairs of differential pins in the USB Type-C port;
providing the data signal to one of a plurality of different digital-to-analog converters (DACs) based on the data signal;
providing the analog audio to the audio system from the one of the plurality of different digital-to-analog converters (DACs) to which the data signal was provided;
determining that the source electronic device should be charged while the analog audio is being provided to the audio system based on a charging signal received via the USB Type-C port; and
charging the source electronic device based on the determination.

18. The method of claim 17, further comprising activating the one of the plurality of different digital-to-analog converters (DACs) to which the data signal was provided via a charging module that also delivers power to the source electronic device.

19. The method of claim 17, wherein the plurality of DACs include a first DAC and a second DAC, the first DAC being configured to process digital audio data received from a first device type, the second DAC being configured to process digital audio data received from second device type different from the first device type.

20. The method of claim 18, wherein the plurality of DACs include a first DAC and a second DAC, the first DAC being activatable responsive to the data signal having a first format, the second DAC being activatable responsive to the data signal having a second format different from the first format, and wherein a configuration signal received over a configuration channel of the USB Type-C connector indicates which pins in the USB Type-C connector are to be used for the data signal and which pins in the USB Type-C connector are to be used for charging of the source electronic device.
